(19) United States
(12) Patent Application Publication
(10) Pub. No.: US 2007/0204296 A1
(43) Pub. Date: Aug. 30, 2007

(54) Digital television signal, method of processing the digital television signal, and digital television receiver

(76) Inventors: Kyung Mee Lee, Seoul (KR); Jin Pil Kim, Seoul (KR)

Correspondence Address: MCKENNA LONG & ALDRIDGE LLP, 1900 K Street, N.W., Washington, DC, 20006, US

(21) Appl. No.: 11/415,306

(22) Filed: May 2, 2006

(30) Foreign Application Priority Data
Feb. 24, 2006 (KR) 10-2006-0018479

(51) Int. Cl. H04N 7/173; G06F 13/00; H04N 5/445

(52) U.S. Cl. 725/39; 725/100; 725/131

(57) ABSTRACT

A digital television signal for use in a digital television receiver for receiving PSIP data from a broadcast transmitter includes a rating region table which includes rating information for multiple geographical regions and a release time field specifying a release time of the rating information. The release time field may be included in a descriptor within the rating region table or in a table ID extension field included in a header of the rating region table, where the table ID extension field serves to establish uniqueness of the rating region table. The release time may be represented as a number of global positioning system (GPS) seconds since a coordinated universal time (UTC). A controller included in the digital television receiver controls storage of the rating region table based upon determining whether the rating information is determined to be newer than pre-stored rating information.

This application claims the benefit of the Korean Patent Application No. 10-2006-0018479, filed on Feb. 24, 2006, which is hereby incorporated by reference as if fully set forth herein.

### BACKGROUND OF THE INVENTION

1. Field of the Invention

The present invention relates to digital television broadcasting, and more particularly, to a digital television signal for receiving program and system information protocol (PSIP) data, a method of processing the digital television signal, and a digital television receiver. Although the present invention is suitable for a wide scope of applications, it is particularly suitable for accurately identifying any update in a rating region table (RRT) without error, each time the RRT is updated.

2. Discussion of the Related Art

A program and system information protocol (PSIP) is defined for parsing messages encoded in specific modes, such as MPEG-2 (moving pictures experts group; ISO/IEC 13818-1 System), so as to provide diverse information on a particular digital broadcast program. The PSIP basically has the same structure as a PSI of the MPEG system. The PSIP may also be configured of a group of tables having the same object or purpose. Herein, each of the tables may be divided into several sections and then transmitted. Such tables include a virtual channel table (VCT), a system time table (STT), a rating region table (RRT), an extended text table (ETT), a direct channel change table (DCCT) and/or a direct channel change selection code table (DCCSCT), an event information table (EIT), a program map table (PMT), and a master guide table (MGT).

More specifically, the STT provides time information of the broadcast program, and the RRT transmits information on a specific region and an advisory committee for the program rating. The ETT provides additional channel and broadcast program description. The DCCT and the DCCSCT are related with automatic (or direct) change in channels. The EIT provides event information (e.g., title, starting time, etc.) of a virtual channel. Finally, the MGT is for managing versions and PID of each of the above-mentioned tables. Particularly, among the above-mentioned tables, the RRT is configured with information of a program rating system existing in a specific region. The RRT is a standard table for a ‘Content_Advisory_Descriptor’, which indicates event schedules and program ratings existing in the EIT or the PMT, wherein information of each event is included.

However, in the related art digital broadcasting, a method for controlling a rating region table (RRT) of the program and system information protocol (PSIP), an RRT data structure, and a digital television receiver processing the same have the following disadvantages. Basically, a large number of broadcast stations manage the PSIP data within a radio frequency range given by each broadcast station. Thus, RRT versions having the same information may become different in each broadcast station. Therefore, a problem of not being able to parse and determine the recent version RRT, when a channel is changed, may occur in the related art digital television receiver.

### SUMMARY OF THE INVENTION

Accordingly, the present invention is directed to a digital television signal for receiving program and system information protocol (PSIP) data, a method of processing the digital television signal, and a digital television receiver that substantially obviate one or more problems due to limitations and disadvantages of the related art.

An object of the present invention is to provide a digital television signal for receiving program and system information protocol (PSIP) data, a method of processing the digital television signal, and a digital television receiver that can accurately identify an update in a rating region table (RRT) without error, each time the RRT is upgraded (or updated).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital television signal for use in a digital television receiver for receiving program and system information protocol (PSIP) data from a broadcast transmitter includes a rating region table which includes rating information for multiple geographical regions, and a release time field which specifies a release time of the rating information. The release time field may be included in a descriptor within the rating region table or in a table ID extension field included in a header of the rating region table, where the table ID extension field serves to establish uniqueness of the rating region table. The release time may be represented as a number of global positioning system (GPS) seconds since a coordinate universal time (UTC).

In another aspect of the present invention, a digital television signal for use in a digital television receiver for receiving PSIP data from a broadcast transmitter includes a rating region table which includes rating information for multiple geographical regions, and a release version field specifying a release version of the rating information. The release version field may be included in a descriptor within the rating region table or in a table ID extension field included in a header of the rating region table.

In another aspect of the present invention, a digital television receiver includes a tuner, a demodulator, a demultiplexer, a decoder, and a controller. The tuner receives a digital television signal from a broadcast transmitter, and the demodulator demodulates the digital television signal. The demultiplexer demultiplexes a broadcast program and a rating region table from the digital television signal demodulated from the demodulator. The decoder decodes and parses the rating region table, where the parsed rating region table includes a release time field specifying a release time of the rating information. Then, the controller determines whether the rating information included in the rating region table is newer than pre-stored rating information and controls storage of the rating region table based upon the determination. For example, it may store the rating region table in a database if the rating information is determined to be newer than the pre-stored rating information. Otherwise, it may discard the rating region table.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the Drawings;

FIG. 1A illustrates a first example of a rating region table (RRT) syntax according to the present invention;

FIG. 1B illustrates an example of a newly defined descriptor in the rating region table (RRT) syntax according to the present invention;

FIG. 1C illustrates another example of a newly defined descriptor in the rating region table (RRT) syntax according to the present invention;

FIG. 1D illustrates a table defining a “release_version” field value shown in FIG. 1C according to the present invention;

FIG. 2A illustrates a second example of a rating region table (RRT) syntax according to the present invention;

FIG. 2B illustrates a third example of a rating region table (RRT) syntax according to the present invention;

FIG. 2C illustrates a table defining a “release_version” field value shown in FIG. 2B;

FIG. 3 illustrates a block diagram of a digital television receiver receiving and processing the RRT of a program and system information protocol (PSIP) according to the present invention; and

FIG. 4 illustrates another example of a flow chart showing process steps of a method for controlling a digital television receiver receiving and processing the RRT of a program and system information protocol (PSIP) according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention is advantageous in that it can accurately detect and determine without error any upgrade (or update) in the RRT regardless of a change in channels. Furthermore, the present invention can maintain compatibility with the original (or pre-stored) RRT.

For a clearer understanding of the present invention, four different embodiments of the present invention will be described herein in detail. The first embodiment describes an example of a method of configuring a RRT syntax according to the present invention; the second embodiment describes another example of a method of configuring a RRT syntax according to the present invention; the third embodiment describes a structure of a digital television receiver receiving and processing the RRT according to the present invention; and the fourth embodiment describes a method for controlling the digital television receiver according to the present invention.

### First Embodiment

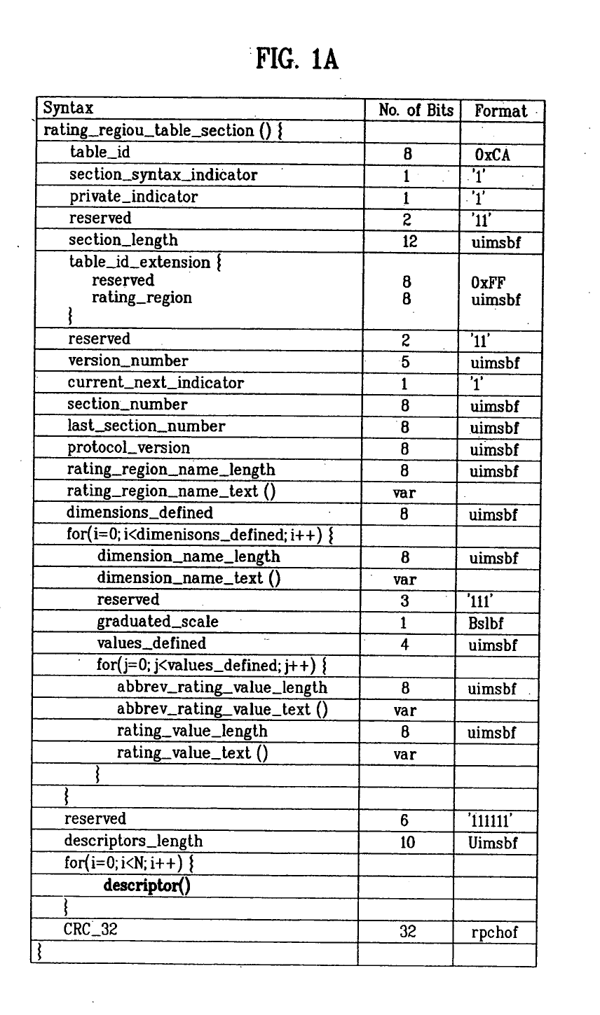

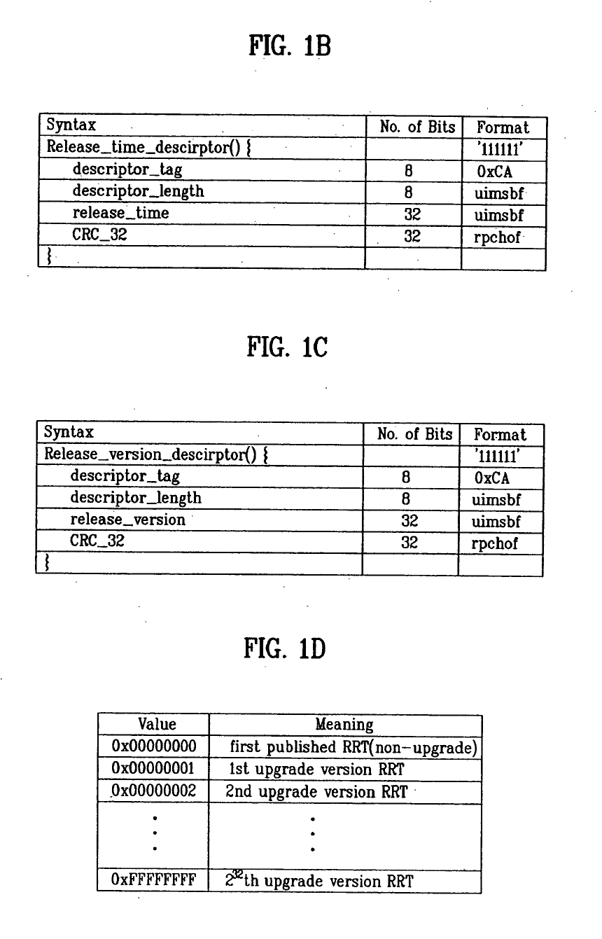

FIG. 1A illustrates a first example of a rating region table (RRT) syntax according to the present invention. FIG. 1B illustrates an example of a newly defined descriptor in the rating region table (RRT) syntax according to the present invention. FIG. 1C illustrates another example of a newly defined descriptor in the rating region table (RRT) syntax according to the present invention. And, FIG. 1D illustrates a table defining a “release_version” field value shown in FIG. 1C according to the present invention. Hereinafter, an example of a method of configuring the RRT syntax will now be described in detail with reference to FIGS. 1A, 1B, 1C, and 1D. The syntax configuring the RRT shown in FIG. 1A will now be described in detail. Furthermore, in order to simplify the description of the first embodiment of the present invention, each field name of the syntax will be marked with quotation marks (e.g., “XXX_YYY_ZZZ”).

The rating region table (RRT) defines rating tables valid for different regions or countries. The rating region table (RRT) carries rating information for multiple geographical regions. Each RRT instance, identified by “rating_region” (the 8 least significant bits of “table_id_extension”), conveys the rating system information for one specific region.

The “table_identification(ID)_extension” field is a 16-bit field and is table-dependent. It shall be considered to be logically part of a “table_id” field providing the scope for the remaining fields. And the “table id_extension” field serves to establish the uniqueness of each RRT instance when the tables appear in transport stream packets with common PID values. In other words, the “table_id_extension” field can be used to serve to establish uniqueness of the rating region table.

The “table_id” field is an 8-bit field, which shall be set to 0xCA, thereby identifying this table as the rating region table (RRT). A “section_syntax_indicator” field is a 1-bit field, which shall be set to ‘1’. This field denotes that the section follows the generic section syntax beyond the section length field. A “private_indicator” field is a 1-bit field, which shall be set to ‘1’. A “section_length” field is a 12-bit field, which specifies the number of remaining bytes in this section immediately following the “section_length” field up to the end of the section. The value of “the section_length” field shall be no larger than 1021.

A “rating_region” field is an 8-bit unsigned integer number, which defines the rating region to be associated with the text in the rating_region_table_section( ). The value of this field is the identifier of this rating region, and thus this field may be used by the other tables (e.g., MGT) for referring to a specific rating region table. A “version_number” field is a 5-bit field, which indicates the version number of the Rating Region Table (RRT) identified by combination of the “table_id” field and the “table_id_extension” field. The version number shall be incremented by 1 modulo 32 when any field in this instance of the RRT changes. The value of this field shall be the same as that of the corresponding entry in MGT.

A “current_next_indicator” field is a 1-bit indicator, which is always set to ‘1’. A “section_number” field is an 8-bit field, which shall always be ‘0x00’. A “last_section_number” field is an 8-bit field, which shall always be ‘0x00’. A “protocol_version” field is an 8-bit field, which shall always be ‘0x00’.

A “rating_region_name_length” field is an 8-bit unsigned integer number, which defines the total length (in bytes) of the rating_region_name_text( ) field to follow. A “rating_region name_text( )” field contains a multiple string structure which represents the rating region name, e.g., “US (50 states+possessions)”, associated with the value given by rating_region. A “dimensions_defined” field is an 8-bit field (1-255), which specifies the number of dimensions defined in the rating_region_table_section( ). Moreover, a “dimension_name_length” field is an 8-bit unsigned integer number, which defines the total length in bytes of the dimension_name_text( ) field to follow. Herein, the “dimension_name_text( )” field contains a multiple string structure which represents the dimension name being described in the loop.

A “graduated_scale” field is a 1-bit flag, which indicates whether or not the rating values in this dimension represent a graduated scale (i.e., higher rating values represent increasing levels of rated content within the dimension). Herein, value ‘1’ means ‘yes’, whereas value ‘0’ means ‘no’. A “values_defined” field is a 4-bit field (1-15), which specifies the number of values defined for this particular dimension. An “abbrev_rating_value_length” field is an 8-bit unsigned integer number, which defines the total length (in bytes) of the abbrev_rating_value_text( ) field to follow. A “abbrev_rating value_text( )” field contains a multiple string structure which represents the abbreviated name for one particular rating value. The abbreviated name for rating value ‘0’ shall be set to a null string, i.e., “ ”.

A “rating_value_length” field is an 8-bit unsigned integer number, which defines the total length (in bytes) of the rating_value_text( ) field to follow. A “rating_value_text( )” field contains a multiple string structure which represents the full name for one particular rating value.

The full name for rating value ‘0’ shall be set to a null string, i.e., “ ”. A “descriptors_length” field means the length (in bytes) of all of the descriptors that follow this field. And, finally, a “descriptor( )” field means that zero or more descriptors, as appropriate, may be included.

Accordingly, information on a time when contents of the RRT being transmitted are decided and released may be included, or information on the upgraded version of the RRT being transmitted may be included. For example, as shown in FIG. 1B, a ‘Release_time_descriptor( )’ is added. Herein, the name of the descriptor is only an exemplary name, and the scope of what is claimed in the present invention should be defined in accordance with the technical spirit denoted within the description of the present invention.

A “descriptor_tag” field is an 8-bit field. When given a specific value, this may indicate that the corresponding descriptor is used as the ‘Release_time_descriptor( )’. Herein, the specific value may be set to ‘0xCA’. Evidently, a different value that has not been used may also be used as the specific value. A “descriptor_length” field is an 8-bit field, which defines the field that is to follow.

A “release_time” field is a 32-bit field, which defines the information specifying a time when contents of the RRT being transmitted are decided and released. Evidently, information on a time that can identify the original (or pre-stored) RRT and the upgraded RRT may be included instead of the time when contents of the RRT being transmitted are decided and released. More specifically, the time may use GPS seconds starting from Jan. 6, 1980, 00:00. For example, when the “release_time” field value is set to ‘0x00000000’ for the RRT having its contents decided on Jan. 6, 1980, 00:00:00, the value of the “release_time” field for the RRT having its contents decided on Jan. 6; 1980, 00:00:15 may be set to ‘0x0000000F’. In other words, for each 1 second that is exceeded, the “release_time” field value is set to be increased by ‘+1’.

GPS (Global Positioning System) time is referenced to the Master Clock at the US Naval Observatory and steered to Coordinated Universal Time (UTC). UTC is the time source we use to set our clocks.

UTC is occasionally adjusted by one-second increments to ensure that the difference between a uniform time scale defined by atomic clocks does not differ from the Earth's rotational time by more than 0.9 seconds. The timing of occurrence of these ‘leap seconds’ is determined by careful observations of the Earth's rotation; each is announced months in advance. On the days it is scheduled to occur, the leap second is inserted just following 12:59:59 PM UTC.

UTC can be directly computed from the count of GPS seconds since Jan. 6, 1980, by subtracting from it the count of leap seconds that have occurred since the beginning of GPS time. In the months just following Jan. 1, 1999, this offset was 13 seconds.

Meanwhile, unlike in the example of FIG. 1B, a ‘Release_version_descriptor( )’ may be included as shown in FIG. 1C. Herein, the name of the descriptor is only an exemplary name, and the scope of what is claimed in the present invention should be defined in accordance with the technical spirit denoted within the description of the present invention.

Evidently, FIG. 1B and FIG. 1C may be represented as one descriptor at the same time. The “descriptor_tag” field is an 8-bit field. When given a specific value, this may indicate that the corresponding descriptor is used as the ‘Release_time_descriptor( )’. The “descriptor_length” field is an 8-bit field, which defines the field that is to follow. The “release_time” field is a 32-bit field, which defines the information on a time when contents of the RRT being transmitted are decided and released. More specifically, if the RRT having the very initially decided contents is referred to as a first published RRT, the RRTs having contents decided later on may be set as RRT having its version increased by 1. In other words, if the RRT is configured as shown in FIG. 1D, the present invention can easily determine the most recent version RRT as the value of the “release_version” field increases.

### Second Embodiment

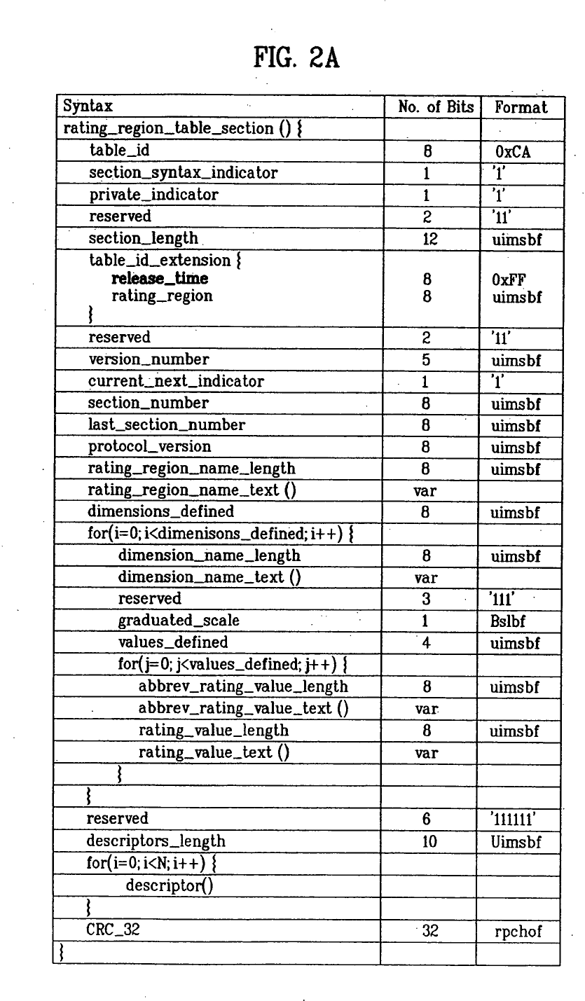

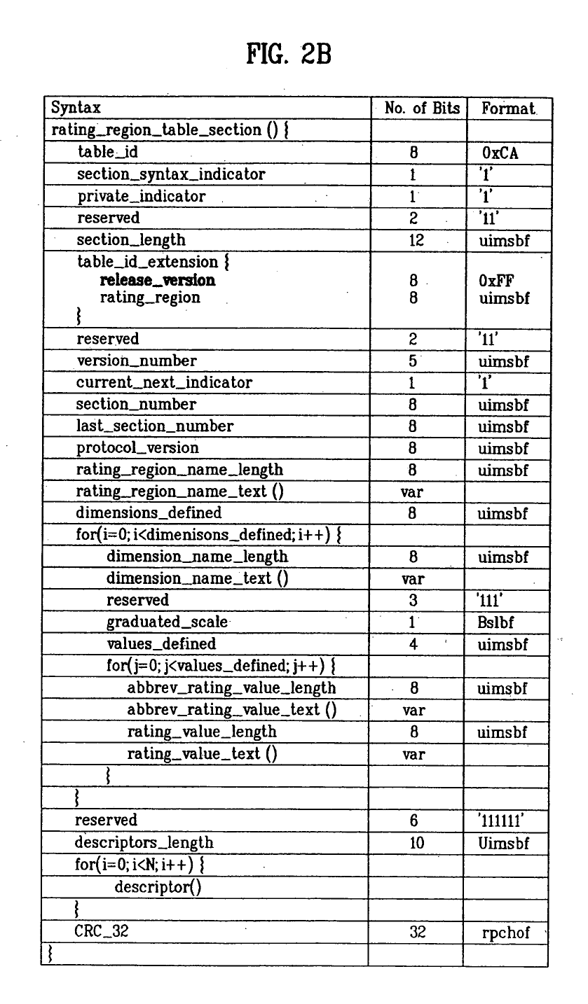

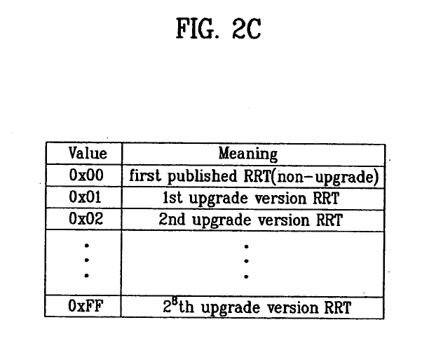

FIG. 2A illustrates a second example of a rating region table (RRT) syntax according to the present invention. FIG. 2B illustrates a third example of a rating region table (RRT) syntax according to the present invention. And, FIG. 2C illustrates a table defining a “release_version” field value shown in FIG. 2B. In the above-described first embodiment of the present invention, information on a release time of the RRT contents or information on a RRT version is added in a descriptor. Conversely, in the second embodiment of the present invention, information on a release time of the RRT contents or information on a RRT version is added in a reserved field. Hereinafter, another example of a method of configuring the RRT syntax will now be described in detail with reference to FIGS. 2A, 2B, and 2C.

As shown in FIG. 2B, a “release_time” field is added in the ‘table_id_extension’. The “release_time” field is an 8-bit field, which defines the information on a time when contents of the RRT being transmitted are decided and released. Evidently, information on a time that can identify the original (or pre-stored) RRT and the upgraded RRT may be included instead of the time when contents of the RRT being transmitted are decided and released. More specifically, the time may use GPS seconds starting from Jan. 6, 1980, 00:00.

Alternatively, as shown in FIG. 2B, a “release version” field is added in the ‘table_id_extension’. More specifically, if the RRT having the very initially decided contents is referred to as a first published RRT, the RRTs having contents decided later on may be set as RRT having its version increased by 1. In other words, if the RRT is configured as shown in FIG. 2C, the present invention can easily determine the most recent version RRT as the value of the “release_version” field increases.

### Third Embodiment

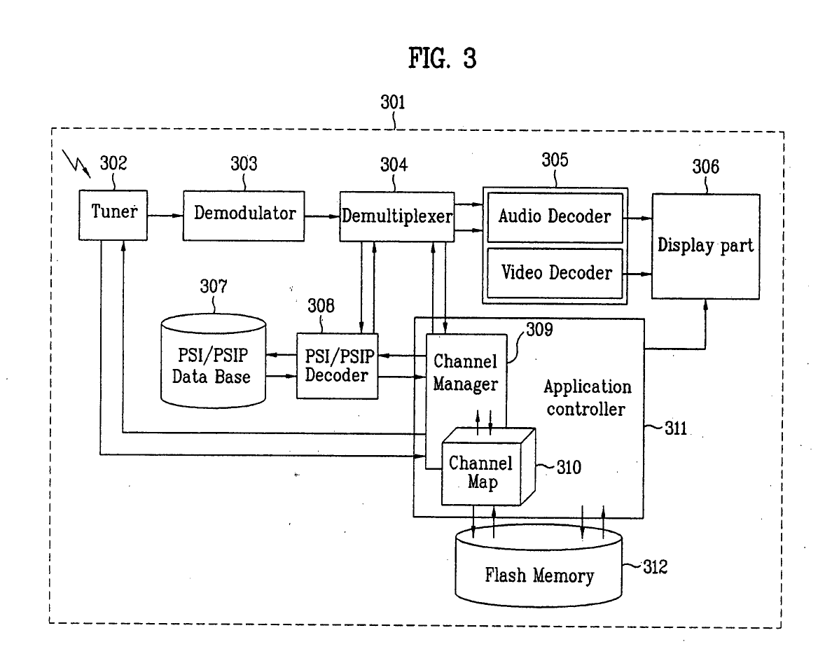

FIG. 3 illustrates a block diagram of a digital television receiver receiving and processing the RRT of a program and system information protocol (PSIP) according to the present invention. Hereinafter, the structure of a broadcast receiver (i.e., a digital television receiver) according to the present invention will now be described in detail with reference to FIG. 3 (and supplementary reference to FIG. 1A to FIG. 2C).

A broadcast receiver 301 according to the present invention includes a tuner 302, a demodulator 303, a demultiplexer 304, an A/V decoder 305, a display 306, a PSI/PSIP database 307, a PSI/PSIP decoder 308, a channel manager 309, a channel map 310, an application controller 311, and a flash memory 312. Herein, for example, the broadcast receiver 301 may be a digital television receiver (DTV) which can receive digital broadcast programs.

The tuner 302 may receive a digital television signal including a program and system information/program and system information protocol (PSI/PSIP) table. Herein, the PSIP table includes a rating region table (RRT). And, the operations of the tuner 302 may be controlled by the channel manager 309.

The tuner 302 can record the result of the received digital television signal in the channel manager 309. The demodulator 303 demodulates the tuned signal received from the tuner 302 to a vestigal side band/enhanced vestigal side band (VSB/EVSB) signal. The demultiplexer 304 demultiplexes the demodulated signal received from the demodulator 303 to audio data, video data, and PSI/PSIP table data. The demultiplexing of the audio data and video data may be controlled by the channel manager 309. On the other hand, the demultiplexing of the PSI/PSIP table data may be controlled by the PSI/PSIP decoder 308. The demultiplexed PSI/PSIP table is transmitted to the PSI/PSIP decoder 308, and the demultiplexed audio data and video data are transmitted to the A/V decoder 305. Thereafter, the A/V decoder 305 decodes the received data.

The PSI/PSIP decoder 308 parses a PSI/PSIP section and reads all remaining actual section data parts which the demultiplexer 304 did not filter during the section filtering, thereby recording the data in the PSI/PSIP database 307. The channel manager 309 refers to the channel map 310 and requests the reception of a channel related information table. Then, the channel manager 309 receives the results.

At this point, the PSI/PSIP decoder 308 controls the demultiplexing of the channel related information table and transmits an A/V PID list to the channel manager 309. The channel manager 309 uses the A/V PID to directly control the demultiplexer 304, thereby controlling the A/V decoder 305. Furthermore, the application controller 311 controls a graphical user interface (GUI) which displays the condition (or state) of the broadcast receiver system on an on-screen display (OSD).

More specifically, according to the present invention, the demultiplexer 304 uses the PID, table ID (table_id), version number (version_number), section number (section_number), and table ID extension (table_id_extension), so as to check a header part of the table being transmitted from a broadcast station. At this point, the demultiplexer 304 filters a desired table section. For example, the demultiplexer 304 filters a RRT section. The PSI/PSIP decoder 308 parses information on the decided or released time of the filtered RRT contents or parses information on the decided or released version of the filtered RRT contents.

As shown in FIG. 1A to FIG. 1D, the information on the decided or released time of the filtered RRT contents or the information on the decided or released version of the filtered RRT contents may be the value of the “release_time” field or the “release_version” field included in the descriptor. Further, as shown in FIG. 2A to FIG. 2C, the information on the decided or released time of the filtered RRT contents or the information on the decided or released version of the filtered RRT contents may be the value of the newly added and defined “release_time” field or “release_version” field included in the reserved field.

The information on the decided or released time of the filtered RRT contents is compared to the information on the decided or released time of the contents of a stored (or ohgirinal g) RRT, which is stored in the PSI/PSIP database 307. As a result of the comparison, if the decided or released time of the filtered RRT contents is newer (or more recent) than the decided or released time of the pre-stored RRT contents, stored in the PSI/PSIP database 307, the PSI/PSIP database 307 is upgraded with the contents of the filtered RRT.

Conversely, as a result of the comparison, if the decided or released time of the filtered RRT contents is the same as or older than the decided or released time of the pre-stored RRT contents, the contents of the filtered RRT are discarded. Evidently, the above-described comparison and upgrading process may also be performed based upon the decided or released version of the RRT contents, instead of the decided or released time of the RRT contents. More specifically, by using the descriptor or the reserved field, the same identification information is given to the same RRT contents. Thus, only the most recent RRT can be received, thereby simplifying the upgrading process and allowing the compatibility with the stored (or pre-sorted) RRT to be maintained.

### Fourth Embodiment

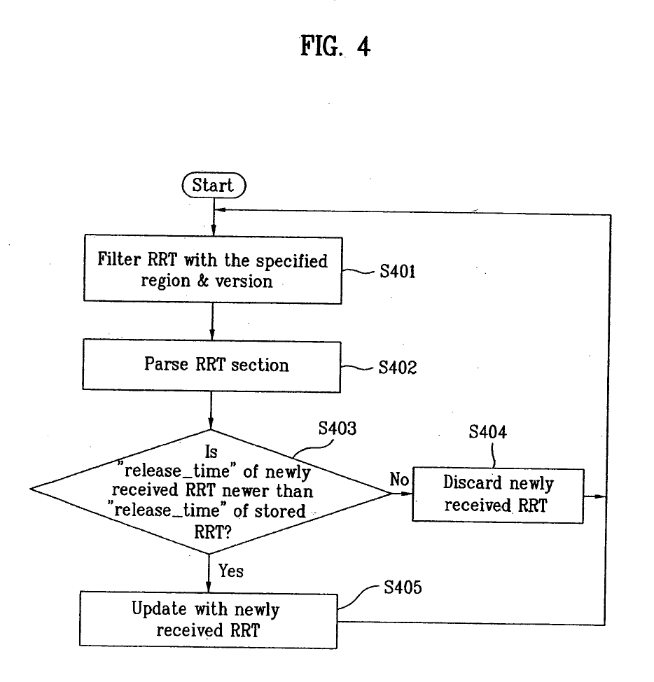

FIG. 4 illustrates another example of a flow chart showing process steps of a method for controlling a digital television receiver receiving and processing the RRT of a program and system information protocol (PSIP) according to the present invention. The method for controlling the digital television receiver according to the present invention will now be described with reference to FIG. 4 (and supplementary reference to FIG. 1A to FIG. 3).

A broadcast receiver 301 (e.g., digital television receiver) is turned on, and a rating region table (RRT) corresponding to a particular region is filtered (S401). Herein, the above-mentioned RRT may be any one of the RRTs shown in FIG. 1A, FIG. 2A, and FIG. 2B. Then, the contents of the filtered RRT are parsed (S402). Herein, the contents of the filtered RRT may include either the information on the decided or released time of the filtered RRT contents, or the information on the decided or released version of the filtered RRT contents. For example, a “release_time” field or a “release_version” field is added to a descriptor or newly defined in a reserved field.

After parsing the RRT contents, a read “release_time” field value of the filtered RRT is compared to a read “release_time” field value of the pre-stored RRT, so as to determine whether the filtered RRT is newer than the pre-stored RRT (S403). As a result of Step 403, if the filtered RRT is newer than the pre-stored RRT, the PSI/PSIP database is updated (or upgraded) with the filtered RRT (S405). Conversely, as a result of Step 403, if the filtered RRT is not newer than (i.e., the same as or older than) the pre-stored RRT, the newly received filtered RRT is discarded (S404). In the above-described example, the “release_time” field is used as the parsed information. However, the “release_version” field may be used in the fourth embodiment of the present invention, instead of the “release_time” field.

As described above, the digital television signal for receiving program and system information protocol (PSIP) data, the method of processing the digital television signal, and the digital television receiver according to the present invention have the following advantages. Each time the contents of a rating region table (RRT) is newly updated (or upgraded) regardless of a change in the program channels, the present invention can accurately determine such update (or upgrade) without error. Moreover, compatibility with the original (or pre-stored) RRT can also be maintained.

Although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital television signal for use in a digital television receiver for receiving program and system information protocol (PSIP) data from a broadcast transmitter, the digital television signal comprising:
a rating region table including rating information for multiple geographical regions, wherein the rating region table further includes a release time field specifying a release time of the rating information.

2. The digital television signal of claim 1, wherein the release time field is included in a descriptor within the rating region table.

3. The digital television signal of claim 1, wherein the rating region table includes a header, the header including a table identification (ID) extension field which serves to establish uniqueness of the rating region table, wherein the release time field is included in the table ID extension field.

4. The digital television signal of claim 1, wherein the release time is represented as a number of global positioning system (GPS) seconds since a coordinated universal time (UTC).

5. The digital television signal of claim 1, wherein the rating region table further includes a release version field specifying a release version of the rating information.

6. The digital television signal of claim 5, wherein the release version indicates how many times the rating information has been upgraded.

7. The digital television signal of claim 5, wherein the release version field is included in a descriptor within the rating region table.

8. The digital television signal of claim 5, wherein the rating region table includes a header, the header including a table identification (ID) extension field which serves to establish uniqueness of the rating region table, wherein the release version field is included in the table ID extension field.

9. A digital television signal for use in a digital television receiver for receiving program and system information protocol (PSIP) data from a broadcast transmitter, the digital television signal comprising:
a rating region table including rating information for multiple geographical regions, wherein the rating region table further includes a release version field specifying a release version of the rating information.

10. The digital television signal of claim 9, wherein the release version field is included in a descriptor within the rating region table.

11. The digital television signal of claim 9, wherein the rating region table includes a header, the header including a table identification (ID) extension field which serves to establish uniqueness of the rating region table, wherein the release version field is included in the table ID extension field.

12. A method of processing a digital television signal in a digital television receiver, the method comprising:
receiving a digital television signal including a broadcast program and a rating region table containing rating information for multiple geographical regions;
parsing the rating region table, the parsed rating region table including a release time field specifying a release time of the rating information; and
storing the rating region table when the rating information is determined to be newer than pre-stored rating information.

13. The method of claim 12, further comprising discarding the rating region table when the rating information included in the rating region table is determined to be not newer than the pre-stored rating information.

14. The method of claim 12, wherein the release time field is included in a descriptor within the rating region table.

15. The method of claim 12, wherein the rating region table includes a header, the header including a table identification (ID) extension field which serves to establish uniqueness of the rating region table, wherein the release time field is included in the table ID extension field.

16. The method of claim 12, wherein the release time is represented as a number of global positioning system (GPS) seconds since a coordinated universal time (UTC).

17. A digital television receiver, comprising:
a tuner arranged to receive a digital television signal;
a demodulator arranged to demodulate the digital television signal;
a demultiplexer arranged to demultiplex a broadcast program and a rating region table from the digital television signal demodulated from the demodulator;
a decoder arranged to parse the rating region table, the parsed rating region table including a release time field specifying a release time of the rating information; and
a controller arranged to store the rating region table in a database when the rating information is determined to be newer than pre-stored rating information.

18. The digital television receiver of claim 17, wherein the controller discards the rating region table when the rating information included in the rating region table is determined to be now newer than the pre-stored rating information.

19. The digital television receiver of claim 17, wherein the release time field is included in a descriptor within the rating region table.

20. The digital television receiver of claim 17, wherein the rating region table includes a header, the header including a table identification (ID) extension field which serves to establish uniqueness of the rating region table, wherein the release time field is included in the table ID extension field.

21. The digital television receiver of claim 17, wherein the release time is represented as a number of global position system (GPS) seconds since a coordinated universal time (UTC).
